(19) United States
(12) Patent Application Publication
(10) Pub. No.: US 2012/0135116 A1
(43) Pub. Date: May 31, 2012

(54) PROCESS FOR PRODUCING A SOY PROTEIN WATER DISPERSION

(75) Inventor: Kevin R. Anderson, Cedar Rapids, IA (US)

(73) Assignee: CARGILL, INCORPORATED, Wayzata, MN (US)

(21) Appl. No.: 13/322,792

(22) PCT Filed: May 10, 2010
(86) PCT No.: PCT/US2010/034170

§ 371 Date: Jan. 31, 2012

Related U.S. Application Data
(60) Provisional application No. 61/182,320, filed on May 29, 2009.

(51) Int. Cl. A23J 3/16; C09D 189/00; A23K 1/00; C09J 189/00

(52) U.S. Cl. 426/250; 106/124.1; 426/656; 426/519; 426/329; 426/331

(57) ABSTRACT

In this disclosure there are provided processes for providing a Soy Protein Flour water dispersion with reduced viscosity. Also provided in the disclosure are Soy Protein Flour dispersions with reduced viscosity, and the use of Soy Protein Flour dispersions with reduced viscosity.

### CROSS REFERENCE TO RELATED APPLICATION

This application claims the benefit of the U.S. Provisional Patent Application Ser. No. 61/182,320, filed 29 May 2009, entitled PROCESS FOR PRODUCING A SOY PROTEIN WATER DISPERSION, which is hereby incorporated by reference in its entirety.

### FIELD

The invention relates generally to a process for producing a soy protein water dispersion with reduced viscosity. The invention further relates generally to a soy protein water dispersion with reduced viscosity produced by the process of the present invention and uses thereof.

### BACKGROUND

Starches and proteins have been used in various adhesives, binders, and coatings applications for many years. For example, starches have been used as binders in the production of paper coatings to bind pigment particles together to form a smooth coating substrate on the paper surface while starch dextrins have been used in the production of paper adhesives for purposes of remoistening sealants and for box carton gluing. Proteins have also been used as binders in paper coatings. In another example, proteins have been used in combination with a water proofing resin as a replacement for resins such as urea/formaldehyde resins in plywood manufacture.

While starches and proteins each provide certain benefits, they both have their respective drawbacks. For instance, starches deliver benefits such as economy and ease of use but they are inferior in their binding ability and surface coating properties such as print gloss. Starch dextrins, in particular, suffer from relatively low dry binding strength compared to other adhesives and do not provide significant water repellency to the dry adhesive. Proteins have better binding ability than starches, however, they have high molecular weights and are very viscous compared to starches. This makes them more difficult to use. For instance, proteins need to be chemically modified and/or depolymerized before use in order to obtain reasonable coating viscosity levels. Similarly, while the combination of protein and water proofing resin provides good binding ability as well as good water repellency to the adhesive, such formulations, particularly those using an unmodified protein, suffer from high viscosity and low solids content compared formulations using urea/formaldehyde, which negatively impacts drying times and overall production rate.

### SUMMARY

In one embodiment, a method is described for producing a soy protein water dispersion having reduced viscosity, the process including the steps of: (a) combining a soy protein material with water to form a soy protein water dispersion having an initial viscosity and (b) holding the soy protein water dispersion at a temperature of from about 20° C. to about 70° C. and for a time period sufficient to reduce the initial viscosity of the soy protein water dispersion.

In a second embodiment, a method is described for producing a soy protein water dispersion having a reduced viscosity where the process includes the steps of (a) combining a soy protein material with water to form a soy protein water dispersion having an initial viscosity and comprising less than about 1% by weight of additives and (b) holding the soy protein water dispersion at a temperature of from about 20° C. to about 70° C. and for a time period sufficient to reduce the initial viscosity of the soy protein water dispersion.

In a third embodiment is described a process for producing an adhesive or binder that includes the steps of (a) combining a soy protein material with water to form a soy protein water dispersion, (b) holding the soy protein water dispersion at a temperature of from about 20° C. to about 70° C. and for a period of time sufficient to reduce the viscosity of the soy protein water dispersion, and after step (b) combining the soy protein water dispersion with an additive. In a further aspect, the additive is selected from the group consisting of biocides, dispersants, dyes, fillers, insolubilizers, lubricants, optical brighteners, pigments, plasticizers, resins, rheology modifiers, salts, tackifiers, viscosity stabilizers, water retention agents, and mixtures thereof.

In yet other embodiments are described an adhesive, binder, food or feed comprising a soy protein water dispersion formed by (a) combining a soy protein material with water to form a soy protein water dispersion having an initial viscosity and (b) holding the soy protein water dispersion at a temperature of from about 20° C. to about 70° C. and for a time period sufficient to reduce the initial viscosity of the soy protein water dispersion.

In still another embodiment is described a soy protein water dispersion having reduced viscosity formed by (a) combining a soy protein material with water to form a soy protein water dispersion having an initial viscosity and (b) holding the soy protein water dispersion at a temperature of from about 20° C. to about 70° C. and for a time period sufficient to reduce the initial viscosity of the soy protein water dispersion.

### DETAILED DESCRIPTION

The invention is directed generally to a process for producing a soy protein water dispersion having a reduced viscosity, the resulting soy protein water dispersion and uses thereof.

Typically, the process for making and using an adhesive formulation begins by combining a soy protein material with water and one or more additives such as dispersants, dyes, plasticizers, resins, etc. The adhesive formulation is then applied to the surfaces to be joined, the surfaces are pressed together to obtain an initial bond, and then the adhesive is left to set for some time at elevated temperature and pressure before a final cooling. Viscosity is an important characteristic in an adhesive formulation. If too viscous, the adhesive formulation may flow poorly over/into the surface of the materials to be joined, may flow poorly through processing equipment, and may not form a truly homogenous composition when mixed with other adhesive components. Attempts to reduce viscosity have included reducing the total solids content of the adhesive formulation. These adhesive formulations are less viscous but they also cure too slowly, set poorly, and have too low a tack to hold the surfaces together until curing is complete.

The invention described herein addresses the viscosity issues of these adhesive formulations by changing the process of making them. In one embodiment, soy protein material is combined with water to form a soy protein water dispersion that is treated to produce a soy protein water dispersion having reduced viscosity that may then be used to formulate various binders and adhesives as well as food and feed products. This process takes advantage of one or more enzymes contained in the soy protein material. In an aspect of the invention, seed pre-growth enzymes from the starting soybean seed are still active in the soy protein material inherited from the starting soybean seed. Water activates these enzymes and heat increases kinetics of this activation/reaction. Various amylases, lipases, oxidases, and proteases have all been reported to be active in viable soybean seeds. It should be noted, however, that the protease enzymes depolymerize the proteins in the soy protein material, which also consequently reduces the adhesive and binding power of adhesive and binder compositions prepared from soy protein material containing added protease enzymes.

The enzymes are generally heat sensitive. Unlike traditional processes which may subject the soy protein material to temperatures that would inhibit these enzymes, the invention identifies temperatures that are particularly effective at activating these enzymes. It has further been discovered that viscosity reduction of the soy protein water dispersion is inhibited by additives and impurities. Thus, in another aspect, the invention combines the soy protein material with water and allows the viscosity reduction process to proceed before other materials, such as additives, are combined with the soy protein water dispersion.

The invention offers several advantages. For example, soy protein water dispersions utilizing the process of the present disclosure, may be used to increase the dry strength and water repellency of starch dextrin-based adhesives, as well as lower the viscosity of the protein-based adhesive formulations without impacting the binding ability of the protein, thus allowing for increased solids formulations. Furthermore, it is expected that use of the new protein comprising compositions may be useful in the preparation of paper coating compositions and paint compositions with higher binding strength and improved gloss development over starch-based binder formulations.

### Soy Protein Material

In one aspect of the invention, the soy protein material includes material derived from defatted oilseed material. The fat may be substantially removed from dehulled oilseeds by a number of different methods. For instance, the fat may be removed by simply pressing the dehulled seeds. The fat may also be removed from the dehulled seeds by extraction with an organic solvent, such as hexane. The solvent extraction process is typically conducted on dehulled oilseeds that have been flattened into flakes. The product of such an extraction is referred to as an oilseed “white flake.” For example, soybean white flake is generally obtained by pressing dehulled soybeans into a flat flake and removing a substantial portion of the residual oil content from the flakes by extraction with hexane. The residual solvent may be removed from the resulting “white flake” by a number of methods. In one procedure, the solvent is extracted by passing the oilseed white flake through a chamber containing hot solvent vapor. Residual hexane may then be removed from soybean white flakes by passage through a chamber containing hexane vapor at a temperature of at least about 75° C. Under such conditions, the bulk of the residual hexane is volatilized from the flakes and may subsequently be removed using processes such as vacuum extraction. The material produced by this procedure is referred to as “flash desolventized oilseed white flake.” The flash desolventized oilseed white flake is then typically ground to produce a granular material. If desired, however, the flash desolventized oilseed white flake may be used directly in the method of the present invention.

Another soy protein material suitable for use in the process of the present invention is derived from material obtained by removing the hexane from the oilseed white flake by a process referred to as “toasting.” In this process, the hexane extracted oilseed white flakes are passed through a chamber containing steam at a temperature of at least about 105° C. This causes the solvent in the flakes to volatilize and be carried away with the steam. The resulting product is referred to as “toasted oilseed flake.” Oilseed materials of this type, such as soybean meal, are used in a wide variety of other applications and are readily available from commercial sources. Other examples of oilseed materials which may be suitable for use include canola meal, linseed meal, sunflower meal, cottonseed meal, peanut meal, lupin meal and mixtures thereof. Cereal-derived proteins, such as wheat gluten or corn gluten meal may also be suitable protein sources for this use.

The chemical and physical properties of the soy protein material can vary based on the thermal history of the oilseed flakes or flour. One measurement that may be used to help assess the degree of heat impact or extent of heating of a protein within the oilseed flake or flour is the Protein Dispersability Index (PDI). The PDI is a measurement of the degree the ground, desolventized oilseed flake or flour may be dispersed in water without particle settling. The PDI is generally determined by measuring the percentage of nitrogen in a sample that may be dispersed in water under standardized conditions, according to AOCS Ba 10a-05.

The PDI is often used to specify the oilseed flake or flour. For instance, typical soy protein flakes prepared with no added heating (untoasted) will have a PDI value greater than 85, and the proteins in the flake can be characterized as native (not denatured), where denaturation refers to the process by which the natural configuration and conformation of the protein is lost due to chemical (acids, bases, chaotropic agents, hydrolases, etc.) or physical (heat, shear, etc.) processes. The properties of the soy protein material may also be shown to be dependent on the extent of native and denatured proteins present in the flake. As such, the PDI may be used as an indicator of certain chemical and physical properties of the soy protein material. Examples of such properties for soy protein materials include protein solubility at neutral pH, viscosity, color, and extent of lysine modification. Hence, a soy protein flake with an intensive thermal history and a PDI of 20 typically forms more viscous dispersions than a soy protein flake having little (PDI of 70) to no (PDI of 90) thermal history.

Three grades of commonly available soy flours are 90 PDI (untoasted), 70 PDI (lightly toasted) and 20 PDI (heavily toasted), but one skilled in the art would recognize that many intermediate grades could be prepared, and that even more extensive heating would result in flours with a lower PDI. Commercial sales of ground protein flour are often expressed in terms of Ground Mesh Size/PDI. A 100/90 for example, is a ground soy protein flour that passes through a 100 mesh screen and has a Protein Dispersability Index of 90%. A 200/20 Soy Protein Flour on the other hand indicates the flour passes through a 200 mesh screen, but has only a 20% PDI.

In one embodiment, soy protein material has a PDI value of from about 20 to about 90. In an alternative embodiment, the soy protein material has a PDI value of from about 70 to about 90.

### Water

In the process of the present disclosure it has been discovered that water quality may have an impact on the rate and extent of viscosity reduction of the soy protein water dispersion. While some inorganic compounds do not seem to affect the viscosity reduction process, some organic materials do seem to inhibit the viscosity reduction. Thus, in one embodiment, the soy protein material is combined with substantially clean water and allow the viscosity reduction process to proceed before other compounds are added to the dispersion mixture. Suitable sources of water include, for example, potable water, distilled water and mixtures thereof.

### Additives

The invention describes processes for producing a soy protein water dispersion having a reduced viscosity and an adhesive or binder that includes forming a soy protein water dispersion having an initial viscosity and comprising less than about 1% by weight of additives. In one aspect of the invention, that additives may be selected from the group consisting of: biocides, dispersants, dyes, fillers, insolubilizers, lubricants, optical brighteners, pigments, plasticizers, resins, rheology modifiers, salts, tackifiers, viscosity stabilizers, water retention agents, and mixtures thereof.

### The Process

The water and soy protein material may be combined in any manner and in any order. In one aspect, the soy protein material is added to the water. In another aspect, the water is added to the soy protein material to create the soy protein water dispersion. In a second aspect, the water is pre-heated before combination with the soy protein material. In a further aspect, the temperature of the soy protein water dispersion is from about 20° C. and about 70° C. Alternatively, the temperature of the soy protein water dispersion is from about 30° C. and about 60° C. And in still a further aspect, the temperature of the soy protein water dispersion is from about 40° C. and about 50° C.

The process of the invention may be conducted for any length of time sufficient to reduce the viscosity of the soy protein water dispersion and one of skill in the art would be able to determine the appropriate length of time based upon the temperature of the soy protein water dispersion, soy protein material and desired viscosity. In one embodiment, a time period of from about 5 minutes to about 20 hours is sufficient to obtain a soy protein water dispersion with reduced viscosity. In another embodiment, a time period of about 30 minutes to about 3 hours may be utilized.

The process of the invention may be conducted at any solids level. Typically, a soy protein water dispersion may have a % solids by weight value ranging from about 1% to about 50%. Alternatively, a soy protein water dispersion has a % solids value ranging from about 10% to about 40%. In a further embodiment, the soy protein water dispersion has a % solids value ranging from about 20% to about 40%. In another embodiment, the soy protein water dispersion has a % solids value ranging from about 30% to about 40%.

The reduced viscosity of the soy protein water dispersion may be any reduction in viscosity as compared to the starting value. Typically, the reduced viscosity may range from about 95% of the initial value to about 1% of the initial value, as determined by dividing the final viscosity value by the initial viscosity value multiplied by 100. In one embodiment, the reduced viscosity may range from about 80% of the initial value to about 2% of the initial value.

The compositions comprising the soy protein water dispersion produced by the process of the invention may be utilized in the production of adhesives and binders. Examples of adhesive applications include, but are not limited to, plaster, joint compound, sealants, corrugating board, laminating adhesives, carton sealants, remoistening adhesives, wood glues, plywood adhesives, strand board adhesives, and the like. Examples of binder applications include, but are not limited to, wallboard, particleboard, ceiling tile, paper coatings, and paints. In the context of this disclosure, adhesives are materials that are used to glue existing substrates together, and binders are materials that are used to bind other materials together to form a new substrate. It is understood however, that adhesive and binder formulations may contain similar ingredients. It is also understood that many aqueous adhesive and binder formulations utilize water in varying degrees of purity. The process of the present disclosure utilizes water that is essentially potable water, although potentially any water source may be utilized such as process water for example.

The process to produce a soy protein water dispersion of the present disclosure may be used to provide adhesive properties in a laminating operation. Typically, laminating formulations comprise 20 parts of an adhesive such as dextrin, 10 parts of a filler such as clay or calcium carbonate, 5 parts of urea or glycerol as a plasticizer, 5 parts of borax as a tackifier and viscosity stabilizer, at a total solids content of 40-50% in a water suspension. The protein compositions produced by the process of the present disclosure may be used to substitute the dextrin component to improve dry adhesion of the laminate, and improve water repellency of the adhesive.

The process to produce a soy protein water dispersion of the present disclosure may be used in the production of plywood. In plywood manufacture, adhesives such as urea-formaldehyde are often used to bond the layers of board together to form the multi-layered plywood. The protein compositions produced by the process of the current disclosure in combination with a water proofing resin may be used to replace the urea-formaldehyde adhesive in plywood manufacture. In a typical formulation, 50 parts of the protein composition may be added to 92 parts of warm water, typically 40 to 50° C., which is then reacted for about 2 to 3 hours. This is then combined with 10 parts of a water-proofing resin such as Kymene resin (Hercules, Inc.), and 20 parts of a plasticizer such as urea, to provide a total solids adhesive formulation of 41% for gluing of multi-ply board. Other additives such as rheology modifiers, biocides, salts, water retention agents, and the like, may be used as desired.

In addition, the process to produce a soy protein water dispersion of the present disclosure may be utilized in the preparation of coatings, such as paper coatings and paints. For example, the protein compositions produced by the process of the present disclosure may be used as a binder in the production of paper coating formulations. Preferably, the protein compositions produced by the process of the present disclosure are in a dispersed form when utilized in the preparation of the paper coatings. Typically, paper coating formulations comprise a pigment such as clay, calcium sulfate, or calcium carbonate; a binder such as latex, polyvinyl alcohol, starch, or protein, and mixtures thereof; and various other additives such as lubricants, insolubilizers, rheology modifiers, optical brighteners, water retention aids, dispersants, biocides, dyes, and the like. It is expected that use of the novel protein compositions produced by the process of the present disclosure in paper coatings will impart improved hydrophobicity, improved ink holdout, and improved printing properties to the coated product.

Typically, in the production of paper coatings there is utilized a pigment in an amount of about 100 parts. The binder component of the paper coating is typically utilized in an amount of about 5 to about 20 parts based on the pigment. Any other ingredients such as lubricants, rheology modifiers, water retention agents, or the like, that are desired in the paper coating may be utilized in well known conventional amounts, such as 0.5 parts based on the pigment.

The coatings incorporating the soy protein water dispersions produced by the process of the current disclosure may be applied to a surface, such as that of a cellulosic web, in any conventional manner. Typically, the coatings may be applied to a surface by the use of a roll coater, a rod coater, a blade coater, a film press coater, an air knife coater, a curtain coater, a spray coater, and the like.

In addition, the process to produce a soy protein water dispersion of the present disclosure may be utilized in foundry applications. For example, in the preparation of taconite pellet manufacture, the soy protein water dispersions of the present disclosure may be used to bind the green taconite ore before firing to form a taconite pellet. The a soy protein water dispersion produced by the process of the present disclosure may be combined with ground taconite ore in sufficient quantity to allow for the formation of green taconite pellets capable of resisting disintegration before the initial firing stage to burn off organic material and create a mineral pellet of sufficient strength to survive transport to foundries.

Also, the process to produce soy protein water dispersions of the present disclosure may be utilized in the production of various food and feed products. Vegetable proteins are a useful nutritional supplement to manufactured foodstuffs and for many animal feed compositions. The soy protein water dispersions produced by the process of the present disclosure may be useful where a reduced viscosity would be a beneficial property for the composition of the food or feed product.

### EXAMPLES

Aspects of certain methods in accordance with aspects of the invention are illustrated in the following examples.

The following test procedures are utilized in evaluating the properties of the products, and the application of the products, provided in the examples.

### Test Procedures

### General Preparation of Adhesives

Soy Protein Flour dispersions were prepared as dry powder dispersions in water as described below.

In the dry preparation for example, the Soy Protein Flour was weighed on a weighing balance accurate to 0.01 g and the dry powder was added slowly to pre-heated water contained in a 750-ml metal beaker secured in a hot water bath. Mechanical agitation was provided by a Lightning mixer with an implosion-type blade design. The dispersions were stirred for 5 minutes and transferred to a 500 mL sealable glass jar and capped. The contents were heated continuously to the indicated time and temperature.

### Application of Adhesive Formulation

2-inch lines were drawn on standard 6×5/8 inch (15×1.75 cm) Tongue Depressors (Crosstex). The calculated area from the end of the tongue depressor to the 2-inch line is equivalent to 1 square inch. Adhesive dispersions from the following Examples were added to the tongue depressor starting at the 2-inch line and coating to the end of the depressor to an approximate depth of ⅛ of an inch. Samples of the depressor with adhesive were placed on a square of standard TAPPI blotter paper and this placed on the bottom platen of a standard TAPPI handsheet press (Noram, Ponte Clare, Quebec, Canada). A second tongue depressor was placed on top of each of the depressors coated with the adhesive such that the 2-inch marking lines matched to the edge of the rounded depressor edge. A second blotter paper square was placed on the sample set and the top platen of the handsheet press was added and secured with the quick screw bolts. The samples were pressed for 5.5 minutes at a pressure of 60 psi. This was considered the wet press cycle. After the wet press cycle, the samples were removed from the handsheet press and placed on an Emerson Speed Dryer (Emerson Apparatus, Portland, Me.) set at a temperature of 250° F. On top of the Speed Dryer lid was placed a 30 lb weight and the samples were hot pressed for 15 minutes. This was considered the hot press cycle. After 15 minutes, the samples were removed from the Speed Dryer and set aside to cool and equilibrate for approximately 20 hours at ambient laboratory conditions. The excess adhesive on the edges of the test strips was removed before testing. Individual samples were then tested for adhesive strength by the method described below.

### Strength Test of Adhesive Formulations

An adhesive strength test of our own design was used to evaluate the binding power of the different compositions. An electric motor connected to an electronic controller with a digital display (ElectroCraft®, Model Motomatic II, Reliance Motion Control, Inc., Eden Prairie, Minn.), was fitted with a ¼ inch shaft (motor drive). A 3-inch diameter rubber O-ring connected this shaft onto another drive shaft/bearing assembly (stationary drive) with a 1.5-inch pulley. To this shaft was fastened one end of a 15-inch nylon cord with a secured loop in the free end of the cord. The motor speed was adjusted so that the 1.5-inch pulley rotated at 12 rpm. Test samples of the glued tongue depressors were secured at the ends by a horizontal, U-shaped platen. The looped end of the nylon cord was placed around test strip at the center of the glued area. This allowed the center of the test sample to be pulled freely by the loop of the nylon cord attached to the electric motor while the edges of the test strips were secured by the horizontal, U-shaped platen. The tension of the O-ring was adjusted by raising or lowering the motor drive relative to the stationary drive to give a blank reading on the activated motor of 3.0-3.5 ounce-inch. A no-load blank was performed before each series of test strip evaluations. This average blank reading was subtracted from the breaking torque recorded for the individual test samples. In order to measure the test sample the motor was switched on and the cord was allowed to become taut due to the resistance of the glued test sample. The digital display indicated a rise in torque placed on the motor. The torque display was monitored until the test sample broke at the center, and the maximum torque reading was recorded. A minimum of five test samples were produced and measured for strength for each condition, and the no-load blank reading was subtracted for each of the five test strip readings. The average values were recorded.

### Viscosity Determination

Viscosity measurements were determined on a Brookfield Viscometer, Model RV DV-I+ (Brookfield Engineering Labs, Inc., Middleboro, Mass.), using a standard spindle set at 20 rpm. Spindle numbers 2 through 7 were generally used. Measurements were taken at the reaction temperature indicated in the individual examples. Test samples were equilibrated to indicated temperature and the spindle was immersed in the sample to the mark indicated on the spindle shaft. Spindle and RPM were recorded for each determination, and readings were taken after 10 seconds of shear time or after a stable reading was observed.

### Example 1

### Preparation of a 20% Solids 90 PDI SOY PROTEIN WATER DISPERSION Adhesive Dispersion at 30° C.

In this example there was used Prolia 100/90 Soy Protein Flour available from Cargill, Inc. 87.5 g of Prolia 100/90 was weighed into a plastic weighing boat on a top loading balance and the dry powder was added slowly with stirring to 350 mL of de-ionized water warmed in a metal beaker inserted and clamped into a hot water bath set to 33° C. which gave a sample temperature of 30° C. The 20% solids dispersion was mixed for 5 minutes. At 4 minutes 30 seconds, 3 drops of MCA 270 defoamer, available from Hydrite, Inc., was added and stirring was continued to the 5-minute mark. The dispersed protein product was then transferred to a 500 mL sealable jar, a viscosity measurement was taken, and the sealed jar placed in a forced air oven set at 30° C. Viscosity measurements were taken and Adhesive Strength determinations were prepared at 30-minute intervals to the 3-hour mark.

### Example 2

### Viscosity and Adhesive Strength Evaluation of Example 1

The Soy Protein Flour adhesive prepared in Example 1 was measured for viscosity and dry strength properties. Generally, the sample was maintained at a temperature of 30° C. in forced air oven before the viscosity was measured, and the adhesive strength test strips were prepared. The viscosity measurement was performed and the adhesive strength test strips were prepared within 1-2 minutes of each other. Viscosity measurements were performed on a Brookfield Viscometer (DV-I+) using the spindle indicated, at a measuring speed of 20 rpm.

Five test strips were prepared for adhesive strength evaluation for each of the indicated times in Example 1 utilizing the Application of Adhesive Method as described. The adhesive strength determinations were made utilizing the Strength Test Method as described. The results of Examples 1-5 are compiled in Tables 1 and 2 below.

TABLE 1
Brookfield Viscosity Measurements in Centipoise

| | 5 | 30 | 60 | 90 | 120 | 150 | 180 | |
|---|---|---|---|---|---|---|---|---|
| Sample | minutes | minutes | minutes | minutes | minutes | minutes | minutes | Spindle # |
| Example 1 | 7500 | 3190 | 565 | 274 | 196 | 176 | 156 | 2, 3 |

From the data in Table 1 the following is observed. As the Soy Protein Flour dispersion is allowed to react, a precipitous drop in viscosity is measured. After approximately 2 hours of reaction, the viscosity of the dispersion is substantially stabilized.

Table 2 describes the results of the adhesive strength determinations.

TABLE 2
Dry Strength Adhesive Breaking Torque Measurements in Oz-in

| Sam- | 5 | 30 | 60 | 90 | 120 | 150 | 180 |
|---|---|---|---|---|---|---|---|
| ple | minutes | minutes | minutes | minutes | minutes | minutes | minutes |
| Ex- | 3.91 | 4.53 | 4.72 | 3.88 | 3.64 | 4.07 | 4.15 |
| am- | | | | | | | |
| ple 1 | | | | | | | |

From the data in Table 2 the following is observed. As the Soy Protein Flour dispersion is allowed to react, no measurable decrease in Dry Strength Adhesion is noted.

It is anticipated that the Soy Protein Flour water dispersion that has been allowed to react to reduce viscosity would have improved runnability in commercial adhesive applicators due to the lower viscosity formulations without loss of binding strength. Alternatively, higher solids levels of the formulations could be achieved due to the lower viscosity levels of the Soy Protein Flour compositions.

### Example 3

### Preparation of a 20% Solids 90 PDI SOY PROTEIN WATER DISPERSION Adhesive Dispersion at 40° C.

In this example there was used Prolia 100/90 Soy Protein Flour available from Cargill, Inc. 87.5 g of Prolia 100/90 was weighed into a plastic weighing boat on a top loading balance and the dry powder was added slowly with stirring to 350 mL of de-ionized water warmed in a metal beaker inserted and clamped into a hot water bath set to 43° C. which gave a sample temperature of 40° C. The 20% dispersion was mixed for 5 minutes. At 4 minutes 30 seconds, 3 drops of MCA 270 defoamer, available from Hydrite, Inc., was added and stirring was continued to the 5-minute mark. The dispersed protein product was then transferred to a 500 mL sealable jar, a viscosity measurement was taken, and the sealed jar placed in a forced air oven set at 40° C. Viscosity measurements were taken and Adhesive Strength determinations were prepared at 30-minute intervals to the 3-hour mark.

### Example 4

### Preparation of a 20% Solids 70 PDI SOY PROTEIN WATER DISPERSION Adhesive Dispersion at 40° C.

In this example there was used Prolia 200/70 Soy Protein Flour available from Cargill, Inc. 87.5 g of Prolia 200/70 was weighed into a plastic weighing boat on a top loading balance and the dry powder was added slowly with stirring to 350 mL of de-ionized water warmed in a metal beaker inserted and clamped into a hot water bath set to 43° C. which gave a sample temperature of 40° C. The 20% dispersion was mixed for 5 minutes. At 4 minutes 30 seconds, 3 drops of MCA 270 defoamer, available from Hydrite, Inc., was added and stirring was continued to the 5-minute mark. The dispersed protein product was then transferred to a 500 mL sealable jar, a viscosity measurement was taken, and the sealed jar placed in a forced air oven set at 40° C. Viscosity measurements were taken and Adhesive Strength determinations were prepared at 30-minute intervals to the 3-hour mark.

### Example 5

### Preparation of a 20% Solids 20 PDI SOY PROTEIN WATER DISPERSION Adhesive Dispersion at 40° C.

In this example there was used Prolia 200/20 Soy Protein Flour available from Cargill, Inc. 87.5 g of Prolia 200/20 was weighed into a plastic weighing boat on a top loading balance and the dry powder was added slowly with stirring to 350 mL of de-ionized water warmed in a metal beaker inserted and clamped into a hot water bath set to 43° C. which gave a sample temperature of 40° C. The 20% solids dispersion was mixed for 5 minutes. At 4 minutes 30 seconds, 3 drops of MCA 270 defoamer, available from Hydrite, Inc., was added and stirring was continued to the 5-minute mark. The dispersed protein product was then transferred to a 500 mL sealable jar, a viscosity measurement was taken, and the sealed jar placed in a forced air oven set at 40° C. Viscosity measurements were taken and Adhesive Strength determinations were prepared at 30-minute intervals to the 3-hour mark.

### Example 6

### Viscosity and Adhesive Strength Evaluation of Example 3-5

The Soy Protein Flour adhesive prepared in Example 1 was measured for viscosity and dry strength properties. Generally, the sample was maintained at a temperature of 40° C. in forced air oven before the viscosity was measured, and the strength test strips were prepared. The viscosity measurement was performed and the strength test strips were prepared within 1-2 minutes of each other. Viscosity measurements were performed on a Brookfield Viscometer (DV-I+) using the spindle indicated, at a measuring speed of 20 rpm.

Five test strips were prepared for adhesive strength evaluation for each of the indicated times and samples of Examples 3-5 utilizing the Application of Adhesive Method as described. The adhesive strength determinations were made utilizing the Strength Test Method as described.

The viscosity and adhesive strength results of Examples 3-5 are compiled in Tables 3 and 4 below.

TABLE 3
Brookfield Viscosity Measurements in Centipoise

| | 5 | 30 | 60 | 90 | 120 | 150 | 180 | |
|---|---|---|---|---|---|---|---|---|
| Sample | minutes | minutes | minutes | minutes | minutes | minutes | minutes | Spindle # |
| Example 3 | 4,995 | 670 | 256 | 180 | 126 | 116 | 112 | 2, 3 |
| Example 4 | 2515 | 2415 | 1965 | 1375 | 950 | 644 | 518 | 2 |
| Example 5 | 1760 | 2280 | 2375 | 2090 | 1900 | 1600 | 1420 | 2 |

From the data in Table 3 the following is observed. The PDI 90 SOY PROTEIN WATER DISPERSION in Example 3 reacted at 40° C. dropped significantly in viscosity after 3 hours of reaction, resulting in a reading that was 2.0% of the starting value. The PDI 70 SOY PROTEIN WATER DISPERSION in Example 4 reacted at 40° C. for 3 hours resulted in a viscosity reading that was 20.6% of the starting value. The PDI SOY PROTEIN WATER DISPERSION 20 SOY PROTEIN WATER DISPERSION in Example 5 reacted at 40° C. for 3 hours resulted in a viscosity reading that was 80.7% of the starting value. These results demonstrate that while all three PDI viscosity levels dropped over the 3-hour period, the higher PDI products drop more significantly than did the lower PDI products.

Table 4 describes the adhesive strength determinations.

TABLE 4
Dry Strength Adhesive Breaking Torque Measurements in Oz-in

| Sam- | 5 | 30 | 60 | 90 | 120 | 150 | 180 |
|---|---|---|---|---|---|---|---|
| ple | minutes | minutes | minutes | minutes | minutes | minutes | minutes |
| Ex- | 3.45 | 2.48 | 2.46 | 2.81 | 2.55 | 2.68 | 2.81 |
| am- | | | | | | | |
| ple 3 | | | | | | | |
| Ex- | 4.20 | 4.45 | 3.67 | 3.84 | 4.83 | 3.69 | 3.31 |
| am- | | | | | | | |
| ple 4 | | | | | | | |
| Ex- | 4.50 | 3.73 | 3.93 | 3.92 | 4.37 | 3.35 | 3.45 |
| am- | | | | | | | |
| ple 5 | | | | | | | |

From the data in Table 4 the following is observed. The PDI 90 SOY PROTEIN WATER DISPERSION in Example 3 reacted at 40° C. dropped slightly in adhesive strength over the 3 hours of reaction. The PDI 70 SOY PROTEIN WATER DISPERSION in Example 4 reacted at 40° C. was variable in adhesive strength over the 3 hours of reaction. The PDI SOY PROTEIN WATER DISPERSION 20 SOY PROTEIN WATER DISPERSION in Example 5 reacted at 40° C. was also variable in adhesive strength over the 3 hours of reaction.

### Example 7

### Preparation of a 20% Solids 90 PDI SOY PROTEIN WATER DISPERSION Dispersion at 50° C.

In this example there was used Prolia 100/90 Soy Protein Flour available from Cargill, Inc. 87.5 g of Prolia 100/90 was weighed into a plastic weighing boat on a top loading balance and the dry powder was added slowly with stirring to 350 mL of de-ionized water warmed in a metal beaker inserted and clamped into a hot water bath set to 53° C. which gave a sample temperature of 50° C. The 20% dispersion was mixed for 5 minutes. At 4 minutes 30 seconds, 3 drops of MCA 270 defoamer, available from Hydrite, Inc., was added and stirring was continued to the 5-minute mark. The dispersed protein product was then transferred to a 500 mL sealable jar, a viscosity measurement was taken, and the sealed jar placed in a forced air oven set at 50° C. Viscosity measurements were taken and Adhesive Strength determinations were prepared at 30-minute intervals to the 3-hour mark.

### Example 8

### Preparation of a 20% Solids 90 PDI SOY PROTEIN WATER DISPERSION Dispersion at 60° C.

In this example there was used Prolia 100/90 Soy Protein Flour available from Cargill, Inc. 87.5 g of Prolia 100/90 was weighed into a plastic weighing boat on a top loading balance and the dry powder was added slowly with stirring to 350 mL of de-ionized water warmed in a metal beaker inserted and clamped into a hot water bath set to 63° C. which gave a sample temperature of 60° C. The 20% dispersion was mixed for 5 minutes. At 4 minutes 30 seconds, 3 drops of MCA 270 defoamer, available from Hydrite, Inc., was added and stirring was continued to the 5-minute mark. The dispersed protein product was then transferred to a 500 mL sealable jar, a viscosity measurement was taken, and the sealed jar placed in a forced air oven set at 60° C. Viscosity measurements were taken and Adhesive Strength determinations were prepared at 30-minute intervals to the 3-hour mark.

### Example 9

### Preparation of a 20% Solids 90 PDI SOY PROTEIN WATER DISPERSION Dispersion at 70° C.

In this example there was used Prolia 100/90 Soy Protein Flour available from Cargill, Inc. 87.5 g of Prolia 100/90 was weighed into a plastic weighing boat on a top loading balance and the dry powder was added slowly with stirring to 350 mL of de-ionized water warmed in a metal beaker inserted and clamped into a hot water bath set to 73° C. which gave a sample temperature of 70° C. The 20% dispersion was mixed for 5 minutes. At 4 minutes 30 seconds, 3 drops of MCA 270 defoamer, available from Hydrite, Inc., was added and stirring was continued to the 5-minute mark. The dispersed protein product was then transferred to a 500 mL sealable jar, a viscosity measurement was taken, and the sealed jar placed in a forced air oven set at 70° C. Viscosity measurements were taken and Adhesive Strength determinations were prepared at 30-minute intervals to the 3-hour mark.

### Example 10

### Viscosity Evaluation of Examples 3, 7-9

The Soy Protein Flour adhesives prepared in Example 7-9 were measured for viscosity properties. Generally, the samples were maintained at the temperature indicated in a forced air oven before the viscosity was measured. Viscosity measurements were performed on a Brookfield Viscometer (DV-I+) using the spindle indicated, at a measuring speed of 20 rpm at the reported reaction temperature.

The results of Examples 3, 7-9 are compiled in Table 5 below.

TABLE 5
Brookfield Viscosity Measurements in Centipoise

| | 5 | 30 | 60 | 90 | 120 | 150 | 180 | |
|---|---|---|---|---|---|---|---|---|
| Sample | minutes | minutes | minutes | minutes | minutes | minutes | minutes | Spindle # |
| Example 3 | 4,780 | 325 | 154 | 122 | 112 | 100 | 94 | 2, 3 |
| Example 7 | 2,652 | 320 | 202 | 175 | 156 | 152 | 144 | 2 |
| Example 8 | 1,525 | 500 | 410 | 360 | 370 | 415 | 425 | 2 |
| Example 9 | 1,425 | 1,025 | 1,300 | 1,850 | 2,455 | 3,200 | 3,300 | 2 |

From the data in Table 3 the following is observed. The PDI 90 SOY PROTEIN WATER DISPERSION reacted at 40° C., 50° C., and 60° C. dropped significantly in viscosity after 3 hours of reaction. The PDI 90 SOY PROTEIN WATER DISPERSION reacted at 70° C. however, rose in viscosity during the 3-hour reaction. These results demonstrate that there is a temperature limit for the reaction to reduce the viscosity of the SOY PROTEIN WATER DISPERSION water dispersion.

### Example 11

### Preparation of a 25% Solids 90 PDI SOY PROTEIN WATER DISPERSION Dispersion at 50° C.

In this example there was used Prolia 100/90 Soy Protein Flour available from Cargill, Inc. 112.5 g of Prolia 100/90 was weighed into a plastic weighing boat on a top loading balance and the dry powder was added slowly with stirring to 337.5 g of de-ionized water warmed in a metal beaker inserted and clamped into a hot water bath set to 53° C. which gave a sample temperature of 50° C. The 25% dispersion was mixed for 5 minutes. At 4 minutes 30 seconds, 3 drops of MCA 270 defoamer, available from Hydrite, Inc., was added and stirring was continued to the 5-minute mark. The dispersed protein product was then transferred to a 500 mL sealable jar, a viscosity measurement was taken, and the sealed jar placed in a forced air oven set at 50° C. Viscosity measurements were taken at 30-minute intervals to the 3-hour mark.

### Example 12

### Preparation of a 27.5% Solids 90 PDI SOY PROTEIN WATER DISPERSION Dispersion at 50° C.

In this example there was used Prolia 100/90 Soy Protein Flour available from Cargill, Inc. 123.75 g of Prolia 100/90 was weighed into a plastic weighing boat on a top loading balance and the dry powder was added slowly with stirring to 326.25 g of de-ionized water warmed in a metal beaker inserted and clamped into a hot water bath set to 53° C. which gave a sample temperature of 50° C. The 27.5% dispersion was mixed for 5 minutes. At 4 minutes 30 seconds, 3 drops of MCA 270 defoamer, available from Hydrite, Inc., was added and stirring was continued to the 5-minute mark. The dispersed protein product was then transferred to a 500 mL sealable jar, a viscosity measurement was taken, and the sealed jar placed in a forced air oven set at 50° C. Viscosity measurements were taken at 30-minute intervals to the 3-hour mark.

### Example 13

### Preparation of a 30% Solids 90 PDI SOY PROTEIN WATER DISPERSION Dispersion at 50° C.

In this example there was used Prolia 100/90 Soy Protein Flour available from Cargill, Inc. 135.0 g of Prolia 100/90 was weighed into a plastic weighing boat on a top loading balance and the dry powder was added slowly with stirring to 315 g of de-ionized water warmed in a metal beaker inserted and clamped into a hot water bath set to 53° C. which gave a sample temperature of 50° C. The 30% dispersion was mixed for 5 minutes. At 4 minutes 30 seconds, 3 drops of MCA 270 defoamer, available from Hydrite, Inc., was added and stirring was continued to the 5-minute mark. The dispersed protein product was then transferred to a 500 mL sealable jar, a viscosity measurement was taken, and the sealed jar placed in a forced air oven set at 50° C. Viscosity measurements were at 30-minute intervals to the 3-hour mark.

### Example 14

### Preparation of a 35% Solids 90 PDI SOY PROTEIN WATER DISPERSION Dispersion at 50° C.

In this example there was used Prolia 100/90 Soy Protein Flour available from Cargill, Inc. 157.5 g of Prolia 100/90 was weighed into a plastic weighing boat on a top loading balance and the dry powder was added slowly with stirring to 292.5 g of de-ionized water warmed in a metal beaker inserted and clamped into a hot water bath set to 53° C. which gave a sample temperature of 50° C. The 35% dispersion was mixed for 5 minutes. At 4 minutes 30 seconds, 3 drops of MCA 270 defoamer, available from Hydrite, Inc., was added and stirring was continued to the 5-minute mark. The dispersed protein product was then transferred to a 500 mL sealable jar, a viscosity measurement was taken, and the sealed jar placed in a forced air oven set at 50° C. Viscosity measurements were taken at 30-minute intervals to the 3-hour mark.

### Example 15

### Preparation of a 40% Solids 90 PDI SOY PROTEIN WATER DISPERSION Dispersion at 50° C.

In this example there was used Prolia 100/90 Soy Protein Flour available from Cargill, Inc. 180.0 g of Prolia 100/90 was weighed into a plastic weighing boat on a top loading balance and the dry powder was added slowly with stirring to 270.0 g of de-ionized water warmed in a metal beaker inserted and clamped into a hot water bath set to 53° C. which gave a sample temperature of 50° C. The 40% dispersion was mixed for 5 minutes. At 4 minutes 30 seconds, 3 drops of MCA 270 defoamer, available from Hydrite, Inc., was added and stirring was continued to the 5-minute mark. The dispersed protein product was then transferred to a 500 mL sealable jar, a viscosity measurement was taken, and the sealed jar placed in a forced air oven set at 50° C. Viscosity measurements were taken at 30-minute intervals to the 3-hour mark.

### Example 16

### Viscosity Evaluation of Examples 11-16

The Soy Protein Flour dispersions prepared in Example 11-16 were measured for viscosity properties. Generally, the sample was maintained at a temperature of 50° C. in a forced air oven before the viscosity was measured. Viscosity measurements were performed on a Brookfield Viscometer (DV-I+) using the spindle indicated, at a measuring speed of 20 rpm.

The results of Examples 7, 11-15 are compiled in Table 6 below.

TABLE 6
Brookfield Viscosity Measurements in Centipoise

| | 5 | 30 | 60 | 90 | 120 | 150 | 180 | |
|---|---|---|---|---|---|---|---|---|
| Sample | minutes | minutes | minutes | minutes | minutes | minutes | minutes | Spindle # |
| Example 7 | 2,652 | 320 | 202 | 175 | 156 | 152 | 144 | 2, 3 |
| Example | 5,850 | 1,450 | 1,280 | 1,125 | 1,095 | 1,105 | 1,145 | 3 |
| 11 | | | | | | | | |
| Example | 14,400 | 5,880 | 4,150 | 4,025 | 4,120 | 4,400 | 4,350 | 5, 6 |
| 12 | | | | | | | | |
| Example | 24,750 | 10,120 | 7,680 | 7,080 | 7,120 | 7,300 | 7,390 | 6 |
| 13 | | | | | | | | |
| Example | 67,800 | 40,800 | 42,500 | 44,650 | 44,200 | 44,450 | 44,680 | 6 |
| 14 | | | | | | | | |
| Example | 200,000 | 140,000 | 109,000 | 90,000 | 101,000 | 103,000 | 105,000 | 7 |
| 15 | | | | | | | | |

From the data in Table 6 the following is observed. The process of the current invention may be used to prepare SOY PROTEIN WATER DISPERSION adhesive dispersions with solids levels to 40% while still in a usable viscosity range (100,000 cps). It is anticipated that the higher solids formulations will result in better runnability in commercial adhesive applicators due to the lower viscosity formulations, and higher throughput due to the lower water content of the adhesives.

### Example 17

### Preparation of a 33% Solids Adhesive Dispersion in a Stepwise Manner

In this example there was used Prolia 100/90 Soy Protein Flour available from Cargill, Inc. 87.5 g of Prolia 100/90 was weighed into a plastic weighing boat on a top loading balance and the dry powder was added slowly with stirring to 350 mL of de-ionized water warmed in a metal beaker inserted and clamped into a hot water bath set to 53° C. which gave a sample temperature of 50° C. The 20% dispersion was mixed for 15 minutes. At 4 minutes 30 seconds, 3 drops of MCA 270 defoamer, available from Hydrite, Inc., was added and stirring was continued. At 15 minutes of mixing, an additional 87.5 g of Prolia 100/90 was then added to the stirring dispersion over a 30 minute period to achieve a solids level equal to 33.3%. The dispersion was stirred for an additional 15 minutes and the dispersed protein product was then transferred to a 500 mL sealable jar, a viscosity measurement was taken, and the sealed jar placed in a forced air oven set at 50° C. Viscosity measurements were taken at 30-minute intervals to the 3-hour mark.

The results of the viscosity determinations are recorded in Table 7 below.

TABLE 7
Brookfield Viscosity Measurements in Centipoise

| | 60 | 90 | 120 | 150 | 180 | |
|---|---|---|---|---|---|---|
| Sample | minutes | minutes | minutes | minutes | minutes | Spindle # |
| Example 17 | 22,150 | 21,250 | 21,150 | 20,900 | 20,750 | 6 |

From the data in Table 7 the following is observed. An alternative process featuring a stepwise addition of Soy Protein Flour may be used to produce a Soy Protein Flour dispersion with reduced viscosity.

### Example 18

### Preparation of a 20% Solids 20 PDI SOY PROTEIN WATER DISPERSION Adhesive Dispersion at 50° C.

In this example there was used Prolia 200/20 Soy Protein Flour available from Cargill, Inc. 87.5 g of Prolia 200/20 was weighed into a plastic weighing boat on a top loading balance and the dry powder was added slowly with stirring to 350 mL of de-ionized water warmed in a metal beaker inserted and clamped into a hot water bath set to 53° C. which gave a sample temperature of 50° C. The 20% solids dispersion was mixed for 5 minutes. At 4 minutes 30 seconds, 3 drops of MCA 270 defoamer, available from Hydrite, Inc., was added and stirring was continued to the 5-minute mark. The dispersed protein product was then transferred to a 500 mL sealable jar, a viscosity measurement was taken, and the sealed jar placed in a forced air oven set at 50° C. Viscosity measurements were taken at 30-minute intervals to the 3-hour mark.

### Example 19

### Preparation of a 20% Solids SOY PROTEIN WATER DISPERSION Dispersion Comprising a 90:10 Blend of PDI 20 and PDI 90 SOY PROTEIN WATER DISPERSION

In this example there was used Prolia 100/90 and Prolia 200/20 Soy Protein Flour available from Cargill, Inc. A dry powder 90:10 blend of 200/20 and 100/90 respectively was prepared by combining 78.75 g of Prolia 200/20 powder with 8.75 g of Prolia 100/90 dry powder in a 400 mL glass beaker on a top loading balance and the dry powder was combined to form a uniform mixture. The dry mixture was added slowly with stirring to 350 mL of de-ionized water warmed in a metal beaker inserted and clamped into a hot water bath set to 53° C. which gave a sample temperature of 50° C. The 20% dispersion was mixed for 5 minutes. At 4 minutes 30 seconds, 3 drops of MCA 270 defoamer, available from Hydrite, Inc., was added and stirring was continued to the 5-minute mark. The dispersed protein product was then transferred to a 500 mL sealable jar, a viscosity measurement was taken, and the sealed jar placed in a forced air oven set at 50° C. Viscosity measurements were taken at 30-minute intervals to the 3-hour mark.

### Example 20

### Viscosity Evaluation of Examples 7, 18, 19

The Soy Protein Flour dispersions prepared in Example 7, 18, 19 were measured for viscosity properties. Generally, the sample was maintained at a temperature of 50° C. in a forced air oven before the viscosity was measured. Viscosity measurements were performed on a Brookfield Viscometer (DV-I+) using the spindle indicated, at a measuring speed of 20 rpm.

The results of Examples 7, 18, 19 are compiled in Table 7 below.

TABLE 7
Brookfield Viscosity Measurements in Centipoise

| | 5 | 30 | 60 | 90 | 120 | 150 | 180 | |
|---|---|---|---|---|---|---|---|---|
| Sample | minutes | minutes | minutes | minutes | minutes | minutes | minutes | Spindle # |
| Example 7 | 2,652 | 320 | 202 | 175 | 156 | 152 | 144 | 2, 3 |
| Example | 1905 | 2360 | 1735 | 1245 | 975 | 865 | 730 | 3 |
| 18 | | | | | | | | |
| Example | 1310 | 1130 | 795 | 605 | 474 | 404 | 384 | 3 |
| 19 | | | | | | | | |

From the data in Table 7 the following is observed. The addition of a low ratio of 100/90 soy protein flour to the 200/20 soy protein flour may be used to achieve lower viscosity adhesive dispersions as compared to the 200/20 soy protein flour dispersion alone.

### Example 21

### Preparation of Protease Enzyme Modified 100/90 PDI SOY PROTEIN WATER DISPERSION

In this example there was used Prolia 100/90 Soy Protein Flour available from Cargill, Inc. 87.5 g of Prolia 100/90 was weighed into a plastic weighing boat on a top loading balance and the dry powder was added slowly with stirring to 350 mL of de-ionized water warmed in a metal beaker inserted and clamped into a hot water bath set to 43° C. which gave a sample temperature of 40° C. The 20% dispersion was mixed for 10 minutes. At 3 minutes, 3 drops of MCA 270 defoamer, available from Hydrite, Inc., was added and stirring was continued. At the 5-minute mark, 100 μl of Neutrase Enzyme, available from Novozyme, Inc., was added and stirring was continued to the 10-minute mark. The dispersed protein containing the enzyme product was then transferred to a 500 mL sealable jar, a viscosity measurement was taken, and the sealed jar placed in a forced air oven set at 40° C. Viscosity measurements were taken and Adhesive Strength determinations were prepared at the 60-minute mark and the 120 minute mark.

The results of the viscosity measurements and adhesive strength measurements are recorded in Table 8 and Table 9 below.

TABLE 8
Brookfield Viscosity Measurements in Centipoise

| | 5 | 30 | 60 | 90 | 120 | 150 | 180 | |
|---|---|---|---|---|---|---|---|---|
| Sample | minutes | minutes | minutes | minutes | minutes | minutes | minutes | Spindle # |
| Example 3 | 4,995 | 670 | 256 | 180 | 126 | 116 | 112 | 2, 3 |
| Sample | 5 min | 10 min | | | 120 min | | | |
| Neutrase | 5,050 | 215 | — | — | 70 | — | — | 2, 3 |
| Enzyme | | | | | | | | |

From the data in Table 8 the following is observed. The viscosity drop over time in the control Example 3 is similar to the soy protein flour dispersions containing the added protease enzyme.

TABLE 9
Dry Strength Adhesive Breaking Torque Measurements in Oz-in

| | | | | | | 150 | 180 |
|---|---|---|---|---|---|---|---|
| | 5 | 30 | 60 | 90 | 120 | min- | min- |
| Sample | minutes | minutes | minutes | minutes | minutes | utes | utes |
| Example 3 | 3.45 | 2.48 | 2.46 | 2.81 | 2.55 | 2.68 | 2.81 |
| | 5 | 10 | | | 120 | | |
| Sample | minutes | minutes | | | minutes | | |
| Neutrase | 3.90 | 2.25 | | | 1.89 | | |
| Enzyme | | | | | | | |

From the data in Table 9 the following is observed. The adhesive strength of the Soy Protein Flour adhesive produced by the process of the present disclosure maintained its adhesive strength compared to the Soy Protein Flour to which protease enzyme had been added.

### Example 22

### Preparation of a 20% Solids 90 PDI SOY PROTEIN WATER DISPERSION Adhesive Dispersion at 85° C.

In this example there was used Prolia 100/90 Soy Protein Flour available from Cargill, Inc. 87.5 g of Prolia 100/90 was weighed into a plastic weighing boat on a top loading balance and the dry powder was added slowly with stirring to 350 mL of de-ionized water warmed in a metal beaker inserted and clamped into a hot water bath set to 87° C. which gave a sample temperature of 85° C. The 20% solids dispersion was mixed for 5 minutes. At 4 minutes 30 seconds, 3 drops of MCA 270 defoamer, available from Hydrite, Inc., was added and stirring was continued for 10 minutes. The dispersed protein product was then transferred to a 500 mL sealable jar, and the sealed jar placed in a forced air oven set at 30° C. A viscosity measurement was taken after the sample had cooled to 30° C. utilizing Spindle #7 at a rotational speed of 20 rpm. The measured viscosity was recorded to be 117,000 cps.

### Example 23

### Preparation of a 20% Solids 90 PDI SOY PROTEIN WATER DISPERSION Adhesive Dispersion at 30° C. Followed by Heating to 85° C.

In this example there was used Prolia 100/90 Soy Protein Flour available from Cargill, Inc. 87.5 g of Prolia 100/90 was weighed into a plastic weighing boat on a top loading balance and the dry powder was added slowly with stirring to 350 mL of de-ionized water warmed in a metal beaker inserted and clamped into a hot water bath set to 33° C. which gave a sample temperature of 30° C. The 20% solids dispersion was mixed for 5 minutes. At 4 minutes 30 seconds, 3 drops of MCA 270 defoamer, available from Hydrite, Inc., was added and stirring was continued to the 5-minute mark. The dispersed protein product was then transferred to a 500 mL sealable jar, a viscosity measurement was taken, and the sealed jar placed in a forced air oven set at 30° C. Viscosity measurements were taken at 30-minute intervals to the 3-hour mark. After 3 hours at a temperature of 30° C. the sealed jar was transferred to a hot water bath set at 87° C. and left to heat until the sample temperature reached 85° C. The sealed jar was then transferred back to the forced air oven and allowed to cool to 30° C. The results of the viscosity determinations are recorded in Table 10.

TABLE 10
Brookfield Viscosity Measurements in Centipoise

| | 5 | 30 | 60 | 90 | 120 | 150 | 180 | | |
|---|---|---|---|---|---|---|---|---|---|
| Sample | minutes | minutes | minutes | minutes | minutes | minutes | minutes | Heated | Spindle # |
| Example | 7,500 | 3190 | 565 | 274 | 196 | 176 | 156 | 2,355 | 3, 4 |
| 23 | | | | | | | | | |

From the data in Table 10 the following is observed. Utilizing the process of the present disclosure, the viscosity of the Soy Protein Flour dispersion after reacting for 3 hours at 30° C. followed by heating to 85° C., results in a viscosity increase to 2,355 cps indicative of a denaturation phase change. When Soy Protein Flour is heated immediately to 85° C., the denatured dispersion results in a high viscosity (Example 22, 117,000 cps). The process of the present disclosure may be useful in preparing food and feed products that require a low viscosity protein source, but also require a heating step for microbiological control.

### Example 24

### Preparation of a 90 PDI SOY PROTEIN WATER DISPERSION Adhesive Dispersion Followed by Kymene Addition

In this example there was used Prolia 200/20 Soy Protein Flour available from Cargill, Inc., and CA1100 Kymene waterproofing resin available from Hercules, Inc. 87.5 g of Prolia 200/20 was weighed into a plastic weighing boat on a top loading balance and the dry powder was added slowly with stirring to 350 mL of de-ionized water warmed in a metal beaker inserted and clamped into a hot water bath set to 53° C. which gave a sample temperature of 50° C. The 20% solids dispersion was mixed for 5 minutes. At 4 minutes 30 seconds, 3 drops of MCA 270 defoamer, available from Hydrite, Inc., was added and stirring was continued to the 5-minute mark. The dispersed protein product was then transferred to a 500 mL sealable jar, a viscosity measurement was taken, and the sealed jar placed in a forced air oven set at 50° C. Viscosity measurements were taken at 30-minute intervals to the 2-hour mark. After 2 hours of reaction, 43.75 g of CA1100 Kymene resin was added to the dispersion. The mixture was stirred for approximately 2 minutes with a laboratory spatula, resealed, and returned to the forced air oven at 50° C. A viscosity measurement was performed at the 2 hours 30 minute mark and at the 3-hour mark.

### Example 25

### Preparation of a PDI 90 Adhesive Dispersion In The Presence of Kymene

In this example there was used Prolia 200/20 Soy Protein Flour available from Cargill, Inc., and CA1100 Kymene waterproofing resin available from Hercules, Inc. 87.5 g of Prolia 200/20 was weighed into a plastic weighing boat on a top loading balance and the dry powder was added slowly with stirring to a mixture of 43.75 g of CA1100 Kymene resin and 306.25 g of de-ionized water warmed in a metal beaker inserted and clamped into a hot water bath set to 53° C. which gave a sample temperature of 50° C. The 20% solids dispersion was mixed for 5 minutes. At 4 minutes 30 seconds, 3 drops of MCA 270 defoamer, available from Hydrite, Inc., was added and stirring was continued to the 5-minute mark. The dispersed protein and Kymene product was then transferred to a 500 mL sealable jar, a viscosity measurement was taken, and the sealed jar placed in a forced air oven set at 50° C. Viscosity measurements were taken at 30-minute intervals to the 3-hour mark.

### Example 26

### Viscosity Evaluation of Examples 24 and 25

The Soy Protein Flour dispersions prepared in Examples 24 and 25 were measured for viscosity properties. Generally, the sample was maintained at a temperature of 50° C. in a forced air oven before the viscosity was measured. Viscosity measurements were performed on a Brookfield Viscometer (DV-I+) using the spindle indicated, at a measuring speed of 20 rpm.

The results of Examples 24 and 25 are compiled in Table 11 below.

TABLE 11
Brookfield Viscosity Measurements in Centipoise

| | 5 | 30 | 60 | 90 | 120 | 150 | 180 | |
|---|---|---|---|---|---|---|---|---|
| Sample | minutes | minutes | minutes | minutes | minutes | minutes | minutes | Spindle # |
| Example | 3,395 | 315 | 175 | 160 | 160 | 950 | 1,040 | 2, 3 |
| 24 | | | | | | | | |
| Example | 955 | 1,450 | 1,840 | 2,020 | 2,155 | 2,225 | 2,280 | 3 |
| 25 | | | | | | | | |

From the data in Table 11 the following is observed. Utilizing the process of the present disclosure, the viscosity of the Soy Protein Flour dispersion after reacting for 2 hours at 50° C. resulted in a reduced viscosity dispersion. Upon addition of Kymene resin the viscosity increased over a 1-hour period. The Soy Protein Flour dispersion that was prepared in the presence of Kymene resin, did not demonstrate the viscosity reduction process of the present disclosure and in fact increased in viscosity over the 3-hour period. This demonstrates that in order to achieve the reduced viscosity Soy Protein Flour dispersion, the SOY PROTEIN WATER DISPERSION and water should be combined prior to the addition of other chemicals.

### Example 27

### Preparation of a Paper Coating Formulation Containing a 100/90 PDI SOY PROTEIN WATER DISPERSION Binder Composition

In this example there was prepared a paper coating color formulation comprising of the follow components: a pigment mixture, a synthetic latex binder, a natural biopolymer binder, a water retention agent, and a lubricant. In this example, the natural biopolymer binder was comprised of a 100/90 PDI Soy Protein Flour produced by the process of the present disclosure.

A paper coating color was prepared utilizing 80 parts of a 60% solids delaminated clay suspension and 20 parts of a 70% solids precipitated calcium carbonate suspension. To a 1-liter mixture of the two pigment suspensions with stirring, was added 10 parts of a 65% solids latex suspension. This was followed by the addition of 5 parts of a 100/90 PDI Soy Protein Flour that had been previously dispersed in water as a 35% solids dispersion and had been reacted for 2 hours at 40° C. 0.5 parts of 10% solids solution of carboxymethyl cellulose was then added, followed by 0.1 parts addition of calcium stearate as a lubricant. The paper coating color continued to be stirred until a homogenous mixture was achieved.

The paper coating color was applied to a standard #5 light weight coated base paper utilizing a laboratory scale rod coater and the coating dried to a uniform moisture level. It is anticipated, that the paper coating color of the present invention would have superior binding characteristics as compared to a paper coating color that utilized a starch as the natural binder component. It is also anticipated that the paper coating color of the present invention would have a lower viscosity than a paper coating color prepared utilizing a soy protein flour, that had not been previously reacted in a water dispersion, as the natural binder.

What is claimed is:

1. A process for producing a soy protein water dispersion, the process comprising the steps of:
(a) combining a soy protein material with water to form a soy protein water dispersion having an initial viscosity; and
(b) holding the soy protein water dispersion at a temperature of from about 20° C. to about 70° C. and for a time period sufficient to reduce the initial viscosity of the soy protein water dispersion.

2. The process of claim 1, wherein the soy protein water dispersion comprises less than about 1% by weight of additives.

3. The process of claim 2, wherein the additives are selected from the group consisting of: biocides, dispersants, dyes, fillers, insolubilizers, lubricants, optical brighteners, pigments, plasticizers, resins, rheology modifiers, salts, tackifiers, viscosity stabilizers, water retention agents, and mixtures thereof.

4. The process of claim 1, further comprising the step of combining the soy protein water dispersion with a defoaming agent.

5. The process of claim 1, wherein the water is heated to a temperature of from about 20° C. to about 70° C. before it is combined with the soy protein material.

6. The process of claim 1, wherein the water is potable water, distilled water or mixtures thereof.

7. The process of claim 1, wherein the soy protein material comprises a soy protein flour with a protein dispersability index of from about 20 to about 90.

8. The process of claim 1, wherein the soy protein material comprises a soy protein flour with a protein dispersability index of from about 70 to about 90.

9. The process of claim 1, wherein the soy protein water dispersion is held at a temperature of from about 40° C. to about 50° C.

10. The process of claim 1, wherein the soy protein water dispersion is held for a time period of from about 5-minutes to about 20-hours.

11. The process of claim 1, wherein the soy protein water dispersion is held for a time period of from about 30-minutes to about 3-hours.

12. The process of claim 1, wherein the soy protein water dispersion has a solids content of from about 1% to about 50%.

13. The process of claim 1, wherein the soy protein water dispersion has a solids content of from about 30% to about 40%.

14. The process of claim 1, wherein the initial viscosity of the soy protein water dispersion is reduced by about 1% to about 95%.

15. A soy protein water dispersion produced according to claim 1.

16. The soy protein water dispersion according to claim 15, wherein the soy protein water dispersion comprises a dry soy protein material with a protein dispersability index of from about 70 to about 90 and wherein the soy protein water dispersion has been held at a temperature of from about 40° C. to about 50° C. for a time period of from about 30-minutes to about 3-hours.

17. An adhesive or binder comprising a soy protein water dispersion produced according to claim 1.

18. The adhesive composition according to claim 17, wherein the adhesive composition is a wood adhesive.

19. The adhesive composition according to claim 17, wherein the adhesive composition is a laminate adhesive.

20. The binder composition according to claim 17, wherein the binder composition is a wood binder.

21. The binder composition according to claim 17, wherein the binder composition is a paper coating.

22. The binder composition according to claim 17, wherein the binder composition is a paint.

23. A process for producing an adhesive or binder, the process comprising the steps of:
(a) combining a soy protein material with water to form a soy protein water dispersion;
(b) holding the soy protein water dispersion at a temperature of from about 20° C. to about 70° C. and for a period of time sufficient to reduce the viscosity of the soy protein water dispersion; and
(c) after step (b) combining the soy protein water dispersion with an additive.

24. The process of claim 23, wherein the additives are selected from the group consisting of: biocides, dispersants, dyes, fillers, insolubilizers, lubricants, optical brighteners, pigments, plasticizers, resins, rheology modifiers, salts, tackifiers, viscosity stabilizers, water retention agents, and mixtures thereof

25. A food composition comprising a Soy Protein Flour water dispersion produced according to claim 1.

26. A feed composition comprising a Soy Protein Flour water dispersion produced according to claim 1.
